(19) United States
(12) Patent Application Publication
(10) Pub. No.: US 2002/0197480 A1
(43) Pub. Date: Dec. 26, 2002

(54) Gas-barrier material, gas-barrier film and method for manufacturing the same

(76) Inventors: Hideki Umekawa, Tokuyama-shi (JP); Yohji Inui, Hikari-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/161,671

(22) Filed: Jun. 5, 2002

(30) Foreign Application Priority Data
Jun. 5, 2001 (JP) 2001-169942
Apr. 5, 2002 (JP) 2002-103212

(51) Int. Cl. B32B 27/38

(52) U.S. Cl. 428/413

(57) ABSTRACT

A gas-barrier material comprising polyvinyl alcohol type resin, silicon alkoxide hydrolyzate and polyethylene oxide is provided. As a gas-barrier film prepared by laminating a gas-barrier layer comprising said gas-barrier material on a thermoplastic resin film and a gas-barrier film prepared by laminating a gas-barrier layer comprising said gas-barrier material on one surface of a thermoplastic resin film and by laminating a sealing layer on the surface of the gas-barrier layer at the opposite side to the surface on which the thermoplastic resin film is laminated are excellent in film appearance and show excellent gas-barrier properties even under high humidity, they can be used favorably as film for wrapping.

### FIELD OF APPLICATION IN INDUSTRIES

The present invention relates to a film for wrapping excellent in gas-barrier properties. More specifically the present invention relates to a gas-barrier film that can maintain high gas-barrier properties even under high humidity and is excellent in appearance.

### PRIOR ART

Thermoplastic resin films such as polypropylene film, polyethylene terephthalate film etc. are widely used as film for wrapping because they have excellent transparency, excellent mechanical strength, good workability (for example, good workability into bags).

Moreover, for the purpose of giving gas-barrier properties, for example, oxygen-barrier properties, to the above-mentioned thermoplastic resin films, there is conducted to laminate on the surface of said films a layer comprising film of a resin having gas-barrier properties such as vinylidene chloride type resin, polyvinyl alcohol type resin etc.

However, a vinylidene chloride type resin film has demerits in incineration and disposal because of being a chlorine-containing resin, in spite of excellent gas-barrier properties. Furthermore, a polyvinyl alcohol type resin film has a problem that its oxygen-barrier properties under high humidity drastically deteriorates through moisture absorption, although it is excellent in oxygen-barrier properties in dry state.

Therefore there have been conducted improvements such as conducting crosslinking treatment or modification treatment to the above-mentioned thermoplastic resin films, or adding a gas-barrier covering layer. For example, Japanese Laid-Open Patent Publication No. 4563/1981 discloses a gas-barrier film made by adding a covering layer comprising silica/polyvinyl alcohol type composite polymer onto a thermoplastic resin film. And Japanese Laid-Open Patent Publication No. 192454/1994 discloses a gas-barrier film made by adding a covering layer comprising a composite of a metal alkoxide or a hydrolyzate of a metal alkoxide and a water-soluble resin having hydroxyl group such as polyvinyl alcohol.

The gas-barrier films described in the above-mentioned Japanese Laid-Open Patent Publications No. 4563/1981 and No. 192454/1994 have given some improvements to the problem that the oxygen-barrier properties under high humidity drastically deteriorates through moisture absorption. However, there was still room to improve the oxygen-barrier properties under particularly high humidity such as exceeding 90% RH.

Moreover, the above-mentioned gas-barrier films had a problem that the thermoplastic resin film and the gas-barrier layer easily separate each other, when wrapping bags were formed after said gas-barrier film had been laminated with a sealant film as a sealing layer due to insufficient adhesion between the thermoplastic resin film and the gas-barrier layer.

In order to solve the above-mentioned problem, the adhesion between the thermoplastic resin film and the gas-barrier layer has been improved generally by adding an anchor coat layer between the thermoplastic resin film and the gas-barrier layer, or by conducting a surface treatment on the thermoplastic resin film.

However, these attempts to increase the adhesion between the thermoplastic resin film and the gas-barrier layer have caused other problems that cracks generate in the process of drying the gas-barrier layer, that the gas-barrier properties remarkably deteriorate, when bending fatigue has been given to the gas-barrier film laminated with a sealing layer, etc.

[Problems the Invention is Going to Solve]

Therefore, one of the purposes of the present invention is to provide a gas-barrier film showing excellent gas-barrier properties even under such a high humidity as exceeding 90% RH. Another purpose of the present invention is to provide a gas-barrier film having an excellent appearance by finding a gas-barrier material that does not generate cracks in the process of drying the gas-barrier layer. Another purpose of the present invention is to provide a gas-barrier film that maintains excellent gas-barrier properties after bending fatigue has been given.

[Means of Solving the Problems]

The present inventers have been intensively continuing research aiming at achieving the above-mentioned purposes. As a result, they have found that the above-mentioned purposes of the present invention can be achieved by using as a gas-barrier material a composition comprising polyvinyl alcohol type resin, silicon alkoxide hydrolyzate and polyethylene oxide.

Thus, according to the present invention there is provided a gas-barrier material comprising polyvinyl alcohol type resin, silicon alkoxide hydrolyzate and polyethylene oxide. Further, according to the present invention there is provided a gas-barrier film made by laminating a gas-barrier layer comprising said gas-barrier material and a thermoplastic resin film. Moreover, according to the present invention there is provided a gas-barrier film made by laminating a sealing layer comprising a thermoplastic resin with a low melting point on the surface of the gas-barrier layer at the opposite side to the surface on which the thermoplastic resin film is laminated in the above-mentioned laminated gas-barrier film.

### MODE OF CARRYING OUT THE INVENTION

As the polyvinyl alcohol type resin in the gas-barrier material of the present invention vinyl alcohol type polymers and their derivatives can be used. There are preferably used, for example, polyvinyl alcohol with 75 mol % or more of saponification degree, polyvinyl alcohol in which 40% or less of the total hydroxyl groups are acetalized, alcohol-soluble modified polyvinyl alcohol, copolymerized polyvinyl alcohol, for example, ethylene-vinyl alcohol copolymer, in which vinyl alcohol units are 60 mol % or more, etc. Above all, polyvinyl alcohol with 80 mol % or more of saponification degree is particularly preferably used because of the transparency and good gas-barrier properties under high humidity of the film obtained therefrom. Degree of polymerization of such polyvinyl alcohol type resin is, in taking the workability into consideration, preferably 300-5000 and more preferably 500-3500.

The silicon alkoxide hydrolyzate in the gas-barrier agent of the present invention includes products of hydrolyzing a part or all of alkoxy groups of a silicon alkoxide, polycondensates of said partial hydrolysis products, polycondensates of silicon alkoxides, products of hydrolyzing a part or all of alkoxy groups of said polycondensates, and a variety of their mixtures.

As the above-mentioned alkoxides there is no particular restriction if hydrolyzates are formable. As specific examples there can be mentioned tetramethoxysilane, tetraethoxysilane, methyltrimethoxysilane, ethyltrimethoxysilane, propyltrimethoxysilane, isopropyltrimethoxysilane, butyltrimethoxysilane, glycidoxymethyltrimethoxysilane, 2-glycidoxyethyltrimethoxysilane, 3-glycidoxypropyltrimethoxysilane, 3-glycidoxypropyltributoxysilane, (3,4-epoxycyclohexyl)methyltripropoxysilane, 2-(3,4-epoxycyclohexyl)ethyltrimethoxysilane, 3-(3,4-epoxycyclohexyl)propyltrimethoxysilane, aminomethyltriethoxysilane, 2-aminoethyltrimethoxysilane, 1-aminoethyltrimethoxysilane, 3-aminopropyltrimethoxysilane, 3-aminopropyltriethoxysilane, N-aminomethylaminomethyltrimethoxysilane, N-aminomethyl-3-aminopropyltrimethoxysilane, N-(2-aminoethyl)-3-aminopropylmethyldimethoxysilane, vinyltrimethoxysilane, vinyltriacetoxysilane, N-β-(N-vinylbenzylaminoethyl)-y-aminopropyltrimethoxysilane, etc.

The silicon alkoxide polycondensates and the products by hydrolyzing a part or all of alkoxy groups of said polycondensates include the products formed as a consequence of polycondensation reaction by dehydration and/or dealcoholation that proceeds simultaneously as the hydrolysis of the above-mentioned silicon alkoxides.

Polyethylene oxide in the gas-barrier material of the present invention is an important component that is indispensable to obtain the effect of the present invention, namely, to maintain high gas-barrier properties even under high humidity, to avoid the generation of cracks in the drying process of the gas-barrier layer in case means to increase the adhesion of the gas-barrier layer has been taken, and to maintain excellent gas-barrier properties even after giving bending fatigue to the gas-barrier film laminated with a sealing layer. The higher the average molecular weight of said polyethylene oxide is, the higher is the effect. The product with an average molecular weight of 100,000 or more is preferable, one with an average molecular weight of 500,000 or more is more preferable and one with an average molecular weight of 2 million or more is even more preferable. The terminal of the molecular chain of said polyethylene oxide may be either hydroxyl group or chemically modified one. Generally, however, it is preferable to have hydroxyl groups at both terminals.

In the gas-barrier material of the present invention other components may be compounded to such an extent as not to damage the present invention. As such other components there can be mentioned, solvents, for example, water; lower alcohols; glycols such as ethylene glycol, propylene glycol etc.; glycol derivatives such as methyl cellosolve, ethyl cellosolve, n-butyl cellosolve etc.; polyhydric alcohols such as glycerol, wax etc.; ethers such as dioxane, trioxane etc.; esters such as ethyl acetate etc.; ketones such as methyl ethyl ketone etc.

As other examples of other components that can be compounded in the gas-barrier material there can be mentioned inorganic fine particles such as kaolin, calcium carbonate, barium sulfate, calcium fluoride, lithium fluoride, calcium phosphate etc.; inorganic layer compounds such as montmorillonite, kaolinite, halloysite, vermiculite, dickite, nacrite, antigorite, pyrophyllite, hectorite, beidellite, margarite, talc, tetrasilicic mica, mica, muscovite, phlogopite, chlorite etc.; crosslinking agents such as urethane type crosslinking agents, isocyanate type crosslinking agents, melamine type crosslinking agents, epoxy type crosslinking agents etc.

In taking into consideration the easiness of the preparation of the gas-barrier material and the easiness of the lamination with the thermoplastic resin film, gas-barrier materials, containing water/lower alcohol mixed solvent as another component, are preferable. As a lower alcohol, alcohols with carbon number of 1-3, namely, methanol, ethanol, n-propyl alcohol and isopropyl alcohol are preferable. The mixing rate of water and a lower alcohol may be suitably chosen in the range of 99/1-20/80 as ratio by weight.

The above-mentioned gas-barrier material may be in a state in which the above-mentioned various components are dispersed and mixed each other or in a state in which they are partly crosslinked.

As a process to prepare the gas-barrier material of the present invention any process can be adopted as long as it can form the composition comprising polyvinyl alcohol type resin, silicon alkoxide hydrolyzate and polyethylene oxide. As such a process there can be mentioned, for example, a process comprising that silicon alkoxide is hydrolyzed by stirring in a solvent at room temperature using a hydrolysis catalyst in the presence of at least either of polyvinyl alcohol type resin and polyethylene oxide or in the absence of both, and that the obtained product is kept stirring at room temperature, after mixing at least either of polyvinyl alcohol type resin and polyethylene oxide thereto, in case of necessity to obtain the desired composition, until a homogeneous phase is formed.

As examples of the catalyst used to hydrolyze a silicon alkoxide there can be mentioned inorganic acids such as hydrochloric acid, nitric acid, sulfuric acid, phosphoric acid etc.; organic acids such as organophosphoric acid, formic acid, acetic acid, acetic anhydride, chloroacetic acid, propionic acid, butyric acid, valeric acid, oxalic acid, malonic acid, succinic acid, glutaric acid, adipic acid, glycolic acid, lactic acid, malic acid, tartaric acid, citric acid, gluconic acid, mucic acid, acrylic acid, methacrylic acid, glutaconic acid, crotonic acid, maleic acid, fumaric acid, itaconic acid, benzoic cid, phthalic acid, isophthalic acid, terephthalic acid, salicylic acid, cinnamic acid, uric acid, barbituric acid, p-toluenesulfonic acid etc.; acid cationic ion exchange resin etc. Above all, an acid cationic ion exchange resin is preferable in taking into consideration the easiness of pH adjustment and simplicity of catalyst removal treatment to be described later, and the transparency of the gas-barrier layer to be obtained etc.

In the above-mentioned preparation process polyvinyl alcohol type resin and silicon alkoxide are preferably used in the mutual proportion of 100/200-100/600, particularly 100/300-100/550 of the ratio by weight of polyvinyl alcohol type resin/silicon alkoxide in order to obtain a gas-barrier material that shows excellent high gas-barrier properties even under high humidity and is highly stable. Further, polyvinyl alcohol type resin and polyethylene oxide are preferably used in the mutual proportion of 100/0.1-100/5, particularly 100/0.5-100/2 of the ratio by weight of polyvinyl alcohol type resin/polyethylene oxide in order to obtain a gas-barrier material that gives excellent film appearance, shows excellent gas-barrier properties even under high humidity, avoids the generation of cracks on the gas-barrier layer even in case means to increase the adhesion of the gas-barrier layer has been taken, and can maintain excellent gas-barrier properties even after giving bending fatigue to the gas-barrier film laminated with a sealing layer.

Solvent is used in an amount sufficient to dissolve the polyvinyl alcohol type resin. Specifically the amount of solvent is suitably chosen in the range that the concentration of the polyvinyl alcohol type resin to the solvent will be 0.1-20%, preferably 1-10%.

In taking into consideration the stability of the gas-barrier material obtained by the above-mentioned preparation process and the coloring of the gas-barrier layer formed of said gas-barrier material, it is preferable to remove the hydrolysis catalyst from the system, after silicon alkoxide has been hydrolyzed. The process to remove the hydrolysis catalyst from the system is not particularly restricted.

There can be mentioned, for example, (1) a process to remove the hydrolysis catalyst from the system, after the polyvinyl alcohol type resin, silicon alkoxide, polyethylene oxide and lower alcohol/water mixed solvent have been mixed, and silicon alkoxide has been hydrolyzed by mixing a hydrolysis catalyst thereto under stirring, (2) a process to mix the polyvinyl alcohol type resin and polyethylene oxide, after silicon alkoxide, lower alcohol/water mixed solvent and a hydrolysis catalyst have been mixed, silicon alkoxide has been hydrolyzed under stirring and the hydrolysis catalyst has been removed from the system of said mixture, (3) a process to remove the hydrolysis catalyst from the system, after silicon alkoxide, lower alcohol/water mixed solvent and a hydrolysis catalyst have been mixed, silicon alkoxide has been hydrolyzed under stirring and then polyvinyl alcohol type resin and polyethylene oxide have been mixed thereto, etc.

Any conventional process can be adopted to remove the hydrolysis catalyst from the system. For example, in case a hydrogen-ionized acid cationic ion exchange resin is used as hydrolysis catalyst, a process of removing it from the system by filtration is preferably adopted. Further, for example, in case an inorganic acid or an organic acid is used as hydrolysis catalyst, a process, in which the anionic component derived from said inorganic acid or said organic acid is ion-exchanged into hydroxide ion by a hydroxide-ionized basic anionic ion exchange resin and then removed from the system by filtration, is preferably adopted.

Hydrolysis reaction of silicon alkoxide is conducted until the liquid phase, that was phase-separated, becomes a homogeneous phase. By this reaction a silicon alkoxide hydrolyzate, comprising partial hydrolyzate, complete hydrolyzate, polycondensates among silicon alkoxide or various mixtures thereof, is formed.

The gas-barrier material of the present invention has preferably pH in the range of 3.0-5.0 from the viewpoint of avoiding the gelation of the gas-barrier material, avoiding the crack generation after formation of a gas-barrier layer and showing good gas-barrier properties under high humidity.

The use of an acid ion exchange resin as hydrolysis catalyst in the present invention is preferably adopted, because it is very easy to adjust pH of the obtained gas-barrier material to the range of 3.0-5.0, the coloring of the gas-barrier is little, the deterioration of gas-barrier properties due to remaining hydrolysis catalyst is little, etc.

According to the present invention there is also provided a gas-barrier film made by laminating a thermoplastic resin film (layer A) and a gas-barrier layer (layer B) comprising a polyvinyl alcohol type resin, silicon alkoxide hydrolyzate and polyethylene oxide. As long as the layers and B are laminated, there is no particular restriction in layer structure. Typically it is 2-layer structure (layer A/layer B). It is possible, however, to add a sealing layer on the layer B, to add an anchor layer between the layer A and layer B, or to add a film layer or an adhesive layer between the sealing layer and layer B, as necessary.

Though not particularly restricted, the layer A used in the present invention is preferably a transparent film in taking its usage for wrapping application into consideration. As the thermoplastic resin constituting the layer A there can be mentioned polyolefin type resin (for example, ethylene homopolymer, random or block copolymer of ethylene and at least one of a-olefins such as propylene, 1-butene, 1-pentene, 1-hexene, 4-methyl-1-pentene etc., random or block copolymer of ethylene and at least one of comonomers such as vinyl acetate, acrylic acid, methacrylic acid, methyl acrylate, methyl methacrylate etc., propylene homopolymer, random or block copolymer of propylene and at least one of a-olefins other than propylene, 1-butene homopolymer, ionomer resin, and a mixture of these polymers); hydrocarbon type resin such as petroleum resin, terpene resin etc.; polyester type resin such as polyethylene terephthalate, polybutylene terephthalate, polyethylene naphthalate etc.; polyamide type resin such as nylon 6, nylon 66, nylon 11, nylon 12, nylon 610, nylon 6/66, nylon 66/610, nylon MXD etc.; acryl type resin such as polymethyl methacrylate etc.; styrene type and acrylonitrile type resins such as polystyrene, styrene-acrylonitrile copolymer, styrene-acrylonitrile-butadiene copolymer, polyacrylonitrile etc.; polyvinyl alcohol type resin such as polyvinyl alcohol, ethylene-vinyl alcohol copolymer etc.; polycarbonate resin; polyketone resin; polymethylene oxide resin; polysulfone resin; polyimide resin; polyamide imide resin etc. They can be used singly or as mixture of 2 kinds or more. Above all, polyolefin type resin, polyester type resin, polyamide type resin, styrene type resin, acrylonitrile type resin, polyvinyl alcohol type resin, polycarbonate resin etc. are preferable and polyolefin type resin, polyester type resin and polyamide type resin are particularly preferable, due to excellent transparency, mechanical strength and suitability for wrapping.

As the forming process of the layer A used in the present invention, known processes can be used without restriction. Specifically solution casting process, T-die extrusion process, tubular die extrusion process, calender process etc. are adopted. Further, the above-mentioned thermoplastic resin film is preferably drawn in taking the mechanical properties into consideration. As the drawing process, known processes can be used without any restriction. There can be mentioned, for example, roll uniaxial drawing, rolling, consecutive biaxial drawing, simultaneous biaxial drawing, tubular drawing etc. Above all, consecutive biaxial drawing and simultaneous biaxial drawing are preferable in taking the thickness accuracy and mechanical properties into consideration.

The thickness of the layer A is not particularly restricted but may be suitably chosen in taking the application etc. into consideration. Generally it is chosen suitably in the range of 1-500 μm. Above all, the range of 5-100 μm is preferable and that of 10-50 μm is more preferable, in taking the drawing workability, gas-barrier properties, workability into bags etc. into consideration.

To the layer A used in the present invention, there can be compounded, as necessary, known additives such as antistatic agent, antifogging agent, anti-blocking agent, heat stabilizer, antioxidant, light stabilizer, nucleating agent, lubricant, ultraviolet absorbent, surface-active agent for the purpose of giving sliding properties and antiblocking properties, etc., to such an extent as not to hinder the effect of the present invention.

The layer A is preferably transparent, in taking the fact into consideration that the gas-barrier film of the present invention is used preferably for wrapping application. Specifically the haze value is preferably 15% or less and more preferably 10% or less.

The process to laminate the layer A and layer B is not particularly restricted, but a process of coating the gas-barrier material onto the layer A as a gas-barrier layer (layer B) and drying it. The above-mentioned gas-barrier material can be coated onto the layer A, after the hydrolysis of silicon alkoxide proceeded and the phase-separated liquid phase has become a homogeneous phase. It is preferable, however, to coat it before the above-mentioned gas-barrier material deteriorates, in taking the generation of cracks and the decline of gas-barrier properties of the obtained gas-barrier layer.

The coating process of the above-mentioned gas-barrier material is not particularly restricted, but a solution or solvent dispersion coating process, with which a thin film coating at high speed is possible, is preferable. Their specific examples are gravure coat, reverse coat, spray coat, kiss coat, die coat, metalling bar coat, gravure coat with chamber doctor, curtain coat etc.

As the process to form the layer B by drying the gas-barrier material coated on the layer A, known drying processes can be used without particular restriction. Specifically there can be mentioned a kind or 2 kinds or more of hot roll contact process, heat medium (air, oil etc.) contact process, infrared heating process, microwave heating process etc. Among them, hot air contact process and infrared heating process are preferable in taking into consideration the finish such as film appearance etc., drying efficiency etc.

The drying condition of the gas-barrier material is not particularly restricted, but it is preferable to adopt the temperature in the range from 80° C. to a lower temperature than the melting point of the layer A, in taking into consideration the expression of gas-barrier properties, drying efficiency etc. The temperature in the range from 100° C. to the lower temperature than the melting point of the layer A by 10° C. is more preferable and the temperature in the range from 120° C. to the lower temperature than the melting point of the layer A by 15° C. is even more preferable. The required drying time is preferably 5 seconds-10 minutes and more preferably 10 seconds-5 minutes, in taking into consideration the gas-barrier properties, drying efficiency etc.

Before and/or after the drying the radiation of high energy ray such as ultraviolet ray, X ray, electronic ray etc. may be conducted, as necessary. Further, a surface treatment such as corona discharge treatment, flame plasma treatment etc. may be conducted directly on the gas-barrier layer after drying, for the purpose of further improving the gas-barrier properties under high humidity.

As the above-mentioned B layer formed by coating the gas-barrier material of the present invention comprising polyvinyl alcohol type resin, silicon alkoxide hydrolyzate and polyethylene oxide and drying it, it is preferable to be:

(1) a mixture of polyvinyl alcohol type resin, polyethylene oxide and partial hydrolysis polycondensates of silicon alkoxide,

(2) a composite of polyvinyl alcohol type resin, polyethylene oxide and said partial hydrolysis polycondensates, or

(3) a mixture of polyvinyl alcohol type resin, polyethylene oxide, said partial hydrolysis polycondensates and said composite.

In the gas-barrier film of the present invention, the thickness of the layer B is not particularly restricted, but the thickness of 0.1 μm or more is preferable, 0.3 μm or more is more preferable and 0.5 μm or more is even more preferable, in taking the gas-barrier properties into consideration. Further, the thickness of the layer B is preferable to be 10 μm or less, more preferable to be 6 μm or less and even more preferable to be 3 μm or less, in taking into consideration the durability of the layer B, economy, secondary workability etc. A gas-barrier film having good gas-barrier properties can be obtained by setting the thickness of the layer B within the above-mentioned range.

In the present invention, it is preferably adopted to conduct an aging treatment after the above-mentioned gas-barrier material has been coated on the layer A and the layer B has been formed by drying it at the above-mentioned temperature.

The aging treatment has an effect to improve the gas-barrier properties of the obtained gas-barrier film, particularly the gas-barrier properties under such a high humidity as exceeding 90% RH. The condition of the aging is determined to such an extent as not to generate damages such as wrinkle, slack etc. at the layer A by the aging. For example, it is chosen in the range of the temperature of 30° C.-50° C. and the relative humidity of 20-100% RH, in case that the thermoplastic resin film is a biaxially drawn polypropylene film. It is preferable to determine the temperature and the relative humidity as high as possible within the limit not to generate damages such as wrinkle, slack etc. at the layer A, because the number of days required for the aging could be reduced.

In the present invention, it is preferable to conduct a surface treatment on the surface at the side, to which the layer B is laminated, of the layer A in order to further improve the adhesion of the layer A and layer B and to further improve the gas-barrier properties and durability of the obtained gas-barrier film.

As the surface treatment, known surface treatment processes can be adopted without any restriction. For example, there can be mentioned corona discharge treatment in the air, corona discharge treatment in the nitrogen gas, corona discharge treatment in the carbon dioxide gas, flame plasma treatment, ultraviolet treatment, ozone treatment, electronic ray treatment, plasma treatment by an excited inert gas etc. Two or more of these surface treatments may be used together.

Further, in the present invention, it is possible to add an anchor coat layer between the layer B and the layer A, on which the above-mentioned surface treatment has been conducted, for the purpose of improving the adhesive strength between the layer A and layer B of the obtained gas-barrier film.

As the anchor coat material used to form the above-mentioned anchor coat layer, known products can be used without particular restriction. There can be mentioned, for example, anchor coat materials of isocyanate type, polyurethane type, polyester type, polyethyleneimine type, polybutadiene type, polyolefin type, alkyl titanate type etc.

Moreover, in the present invention, a sealing layer, comprising polyolefin type resin such as polyethylene, ethylene-vinyl acetate copolymer, ethylene-methacrylate copolymer, etc.; polyester type resin such as polyethylene terephthalate, polybutylene terephthalate, polyethylene naphthalate, etc.; acryl type resin such as polymethyl methacrylate etc.; styrene type and acrylonitrile type resins such as polystyrene, styrene-acrylonitrile copolymer, styrene-acrylonitrile-butadiene copolymer, polyacrylonitrile, etc., may be laminated to the outmost layer of the above-mentioned structure, on the surface of the layer B (gas-barrier layer) at the opposite side to the surface on which the layer A (thermoplastic resin film) is laminated, for the purpose of giving heat seal properties, bending resistance, etc.

The gas-barrier properties after Gelbo-Flex-Test of the gas-barrier film laminated with a sealing layer of the present invention are preferably 100 cc/m²·day·atm or less and more preferably 50 cc/m²·day·atm or less, in taking into consideration that good gas-barrier properties should be shown in case contents are packed, transported, stored or handled.

The application of the gas-barrier film of the present invention is not particularly restricted. It is, however, particularly preferable, as a film for food packaging showing wide water activities, for example, as a film for package of dry foods such as snacks etc., foods with medium water content such as delicacies, wet noodles, unbaked sweets etc. and foods with high water content such as salty cooked seafood (TSUKUDANI), pickled vegetables etc.

Then the present invention will be described by Examples and Comparative Examples. The present invention, however, should not be restricted to these examples. Physical properties of film in the following Examples and Comparative Examples were measured by the following methods.

(1) Gas-Barrier Properties (Oxygen Permeation and Transmission Rate)

Oxygen permeation and transmission rate of a gas-barrier film in the state as being formed and that of a gas-barrier film after Gelbo-Flex Test was conducted were measured according to JIS K7126 B by using Oxygen Permeation and Transmission Rate Measurement System (OX-TRAN100; made by Mocon, Inc.). Measurement was conducted under the condition of the temperature of 23° C. and humidity of 93% RH. Moisture control was conducted by using Precision Moisture Control System RH-3S type made by Hitachi Instruments Service Co., Ltd.

(2) Gelbo-Flex Test

Gelbo-Flex Test of 50 times were conducted by using Gelbo-Flex tester (BE-1006; made by Tester Sangyo Co., Ltd.) and setting the film sample in a tubular form with the gas-barrier layer inside under the condition of twisting angle of 440°/400°, twisting stroke of 89 mm×440°/82.6 mm×400° and straight stroke of 63.5 mm.

(3) Coating

A gas-barrier layer was formed by coating the gas-barrier material on a thermoplastic resin film by using a test coater made by Akatsuki Machinery Co., Ltd. and drying.

Coat system: Gravure system

Drying process: Guide roll arch type hot air jet nozzle blowing type

(4) Film Color

Color of the obtained gas-barrier film was visually evaluated.

(5) Film Appearance

Appearance of the obtained gas-barrier film was visually evaluated.

### EXAMPLE 1

To a mixed solvent comprising 70 parts by weight of water and 30 parts by weight of ethanol, polyvinyl alcohol with average degree of polymerization of 500 and saponification rate of 98% or more was dissolved so that its concentration would be 5% to obtain 5% solution of polyvinyl alcohol. To 100 parts by weight of said polyvinyl alcohol solution, 0.05 pars by weight of polyethylene oxide with average molecular weight of 4 million was added to obtain a mixed solution of polyvinyl alcohol and polyethylene oxide. To said mixed solution, 25 parts by weight of tetraethoxysilane and hydrogen-ionized strong acid ion exchange resin in bead form were added and the mixture was stirred at room temperature until it became homogeneous phase with the progress of the hydrolysis of tetraethoxysilane. Then the cationic ion exchange resin was removed by filtration to obtain a gas-barrier material. The obtained gas-barrier material is a transparent liquid with pH of 4.2. The ratio by weight of polyvinyl alcohol/tetraethoxysilane in said gas-barrier material is 100/500 and the ratio by weight of polyvinyl alcohol/polyethylene oxide is 100/1.

On the corona discharge-treated surface of a corona discharge-treated, biaxially drawn polypropylene film of 20 μm thickness, an anchor coat material (product obtained by adjusting the main agent AD335AE/hardening agent CAT10=10 parts by weight/1 part by weight; made by Toyo-Morton, Ltd. with a mixed solvent ethyl acetate/toluene=1 part by weight/1 part by weight to non-volatile matter concentration of 6% by weight) was coated so that the dry weight of the anchor coat layer would be 0.4g/m² and it was dried by hot air at 100° C. to obtain a biaxially drawn polypropylene film coated with the anchor coat material.

On the anchor coat layer of said biaxially drawn polypropylene film coated with said anchor coat material, the gas-barrier material obtained as mentioned above was coated so that the thickness of the gas-barrier layer after drying would be 0.1 μm, and dried by hot air at 120° C. Then the obtained film was subjected to an aging treatment for 4 days at 40° C. under 60% RH to obtain a gas-barrier film.

About the obtained gas-barrier film, oxygen barrier properties were measured, and the film color and film appearance were evaluated. Results are shown in Table 1.

### EXAMPLE 2

A gas-barrier material was obtained in the same manner as Example 1, except using polyvinyl alcohol with average degree of polymerization of 1700 and saponification rate of 98% or more as polyvinyl alcohol. A film was obtained in the same manner as Example 1 by using said gas-barrier material. Then said film was subjected to an aging treatment for 4 days at 40° C. under 60% RH to obtain a gas-barrier film.

Results of measurement and evaluation of the obtained gas-barrier film are shown in Table 1.

### EXAMPLE 3

A gas-barrier material was prepared in the same manner as Example 1, except

that 22 parts by weight of tetraethoxysilane was added to 100 parts by weight of 5% solution of polyvinyl alcohol. The ratio by weight of polyvinyl alcohol/tetraethoxysilane in said gas-barrier material is 100/440. A gas-barrier film was obtained in the same manner as Example 1 by using said gas-barrier material.

Physical properties of the obtained gas-barrier film are shown in Table 1.

### EXAMPLE 4

A gas-barrier material was prepared in the same manner as Example 1, except that 20 parts by weight of tetraethoxysilane was added to 100 parts by weight of 5% solution of polyvinyl alcohol. The ratio by weight of polyvinyl alcohol/tetraethoxysilane in said gas-barrier material is 100/400. A gas-barrier film was obtained in the same manner as Example 1 by using said gas-barrier material.

Physical properties of the obtained gas-barrier film are shown in Table 1.

### EXAMPLE 5

A gas-barrier material was prepared in the same manner as Example 1, except that 17.4 parts by weight of tetraethoxysilane was added to 100 parts by weight of 5% solution of polyvinyl alcohol. The ratio by weight of polyvinyl alcohol/tetraethoxysilane in said gas-barrier material is 100/350. A gas-barrier film was obtained in the same manner as Example 1 by using said gas-barrier material.

Physical properties of the obtained gas-barrier film are shown in Table 1.

### EXAMPLE 6

A gas-barrier material was prepared in the same manner as Example 1, except that 15 parts by weight of tetraethoxysilane was added to 100 parts by weight of 5% solution of polyvinyl alcohol. The ratio by weight of polyvinyl alcohol/tetraethoxysilane in said gas-barrier material is 100/300. A gas-barrier film was obtained in the same manner as Example 1 by using said gas-barrier material.

Physical properties of the obtained gas-barrier film are shown in Table 1.

### EXAMPLE 7

A gas-barrier material was prepared in the same manner as Example 1, except that 12.5 parts by weight of tetraethoxysilane was added to 100 parts by weight of 5% solution of polyvinyl alcohol. The ratio by weight of polyvinyl alcohol/tetraethoxysilane in said gas-barrier material is 100/250. A gas-barrier film was obtained in the same manner as Example 1 by using said gas-barrier material.

Physical properties of the obtained gas-barrier film are shown in Table 1.

### EXAMPLE 8

A gas-barrier material and a gas-barrier film were obtained in the same manner as Example 1, except using 2 parts by weight of polyethylene oxide with average molecular weight of 1 million.

Measurement results of the obtained gas-barrier film are shown in Table 1.

### EXAMPLE 9

A gas-barrier material was prepared in the same manner as Example 2, except that using 0.6N-hydrochloric acid instead of the hydrogen-ionized strong acid ion exchange resin in Example 2 the mixture was stirred at room temperature until it became homogeneous phase with the progress of the hydrolysis of tetraethoxysilane. Said gas-barrier material is a transparent liquid with pH of 3.8.

A gas-barrier film was obtained in the same manner as Example 2 by using said gas-barrier material.

Physical properties of the obtained gas-barrier film are shown in Table 1.

### EXAMPLE 10

The gas-barrier material obtained in Example 2 was coated on was coated on the corona discharge-treated surface of a corona discharge-treated, biaxially drawn polypropylene film Of 20 μm thickness so that the thickness of the gas-barrier layer after drying would be 1.0 μm, and dried by hot air at 120° C. to obtain a film. Then the obtained film was subjected to an aging treatment for 4 days at 40° C. under 60% RH to obtain a gas-barrier film.

Physical properties of the obtained gas-barrier film are shown in Table 1.

### EXAMPLE 11

A gas-barrier film was obtained in the same manner as Example 2, except that the gas-barrier material obtained in Example 2 was coated on the anchor coat layer of the biaxially drawn polypropylene film coated with the same anchor coat material as in Example 1 so that the thickness of the gas-barrier layer after drying would be 1.0 μm, and dried by hot air at 100° C.

Physical properties of the obtained gas-barrier film are shown in Table 1.

### EXAMPLE 12

On the corona discharge-treated surface of a corona discharge-treated, biaxially drawn polyethylene terephthalate film of 12 μm thickness, an anchor coat material (product obtained by adjusting the main agent AD335AE/hardening agent CAT10=10 parts by weight/1 part by weight; made by Toyo-Morton, Ltd. with a mixed solvent ethyl acetate/toluene=1 part by weight/1 part by weight to non-volatile matter concentration of 6% by weight) was coated so that the dry weight of the anchor coat layer would be 0.4 μm² and it was dried by hot air at 100° C. to obtain a biaxially drawn polyethylene terephthalate film coated with the anchor coat material.

On the anchor coat layer of said biaxially drawn polyethylene terephthalate film coated with said anchor coat material, the gas-barrier material obtained in Example 2 was coated so that the thickness of the gas-barrier layer after drying would be 1.0 μm, and dried by hot air at 120° C. to obtain a film. Then the obtained film was subjected to an aging treatment for 4 days at 40° C. under 60% RH to obtain a gas-barrier film.

Physical properties of the obtained gas-barrier film are shown in Table 1.

### COMPARATIVE EXAMPLE 1

A gas-barrier material was obtained in the same manner as Example 1 except without addition of polyethylene oxide. It was tried to coat said gas-barrier material on the anchor coat layer of a biaxially drawn polypropylene film coated with an anchor coat material in the same manner as in Example 1. Said gas-barrier material, however, could not be spread on the whole surface of the film but there partly generated cissing.

### COMPARATIVE EXAMPLE 2

A gas-barrier material was obtained in the same manner as Example 2 except without addition of polyethylene oxide. The gas-barrier material could be coated on the whole surface without generating cissing. But after drying with hot air there generated cracks in the gas barrier layer. The obtained film was subjected to an aging treatment for 4 days at 40° C. under 60% RH to obtain a gas-barrier film.

The measurement results of the obtained gas-barrier film are shown in Table 1.

### COMPARATIVE EXAMPLE 3

A gas-barrier material was obtained in the same manner as Example 1 except without addition of polyethylene oxide. Said gas-barrier material was coated, after being kept standing at room temperature for a day, on the anchor coat layer of a biaxially drawn polypropylene film coated with an anchor coat material in the same manner as in Example 1. The gas-barrier material, kept standing for a day, could coat the whole surface without generating cissing. There generated, however, cracks in the gas barrier layer after drying with hot air at 120° C. The obtained film was subjected to an aging treatment for 4 days at 40° C. under 60% RH to obtain a gas-barrier film.

The measurement results of the obtained gas-barrier film are shown in Table 1.

### COMPARATIVE EXAMPLE 4

A gas-barrier material was prepared in the same manner as Example 5 except without addition of polyethylene oxide. The obtained gas-barrier material was coated, after being kept standing at room temperature for a day, on the corona discharge-treated surface of a corona discharge-treated, biaxially drawn polypropylene film Of 20 μm thickness so that the thickness of the gas-barrier layer after drying would be 1.0 μm, and dried by hot air at 120° C. to obtain a film. Then the obtained film was subjected to an aging treatment for 4 days at 40° C. under 60% RH to obtain a gas-barrier film.

The measurement results of the obtained gas-barrier film are shown in Table 1.

TABLE 1

| | Oxygen permeation and | | |
|---|---|---|---|
| | transmission rate | Film | |
| Example | (cc/m²•day•atm) | appearance | Film color |
| Example 1 | 0.6 | No crack | Colorless |
| | | | transparent |
| Example 2 | 0.4 | No crack | Colorless |
| | | | transparent |
| Example 3 | 2.2 | No crack | Colorless |
| | | | transparent |
| Example 4 | 4.4 | No crack | Colorless |
| | | | transparent |
| Example 5 | 7.5 | No crack | Colorless |
| | | | transparent |
| Example 6 | 24 | No crack | Colorless |
| | | | transparent |
| Example 7 | 12 | No crack | Colorless |
| | | | transparent |
| Example 8 | 6.8 | No crack | Colorless |
| | | | transparent |
| Example 9 | 1.0 | No crack | Yellow |
| Example 10 | 0.9 | No crack | Colorless |
| | | | transparent |
| Example 11 | 0.8 | No crack | Colorless |
| | | | transparent |
| Example 12 | 0.6 | No crack | Colorless |
| | | | transparent |
| Comparative | 2.1 | Cracks | Colorless |
| Example 2 | | appear | transparent |
| Comparative | 75 | Cracks | Colorless |
| Example 3 | | appear | transparent |
| Comparative | 130 | No crack | Colorless |
| Example 4 | | | transparent |

### EXAMPLE 13

On the gas-barrier layer of the gas-barrier film obtained in Example 1, an adhesive for dry laminate (product obtained by adjusting the main agent TM329/hardening agent CAT-8B=1 part by weight/1 part by weight; made by Toyo-Morton, Ltd. with the solvent ethyl acetate to non-volatile matter concentration of 10% by weight) was coated so that its dry weight would be 2 g/m² and dried at 90° C. for 2 minutes, and then a non-drawn polyethylene film of 40 μm was laminated on the surface, on which said adhesive for dry laminate was coated, to obtain a gas-barrier film laminated with non-drawn polyethylene film.

About the obtained gas-barrier film gas-barrier properties before and after Gelbo-Flex Test were measured and the results are shown in Table 2.

### EXAMPLE 14

In the same manner as Example 13, a gas-barrier film laminated with non-drawn polyethylene film was obtained by laminating a non-drawn polyethylene film of 40 μm on the gas-barrier layer of the gas-barrier film obtained in Example 2.

Film properties of the obtained gas-barrier film are shown in Table 2.

### EXAMPLE 15

In the same manner as Example 13, a gas-barrier film laminated with non-drawn polyethylene film was obtained by laminating a non-drawn polyethylene film of 40 μm on the gas-barrier layer of the gas-barrier film obtained in Example 3.

Film properties of the obtained gas-barrier film are shown in Table 2.

### EXAMPLE 16

In the same manner as Example 13, a gas-barrier film laminated with non-drawn polyethylene film was obtained by laminating a non-drawn polyethylene film of 40 μm on the gas-barrier layer of the gas-barrier film obtained in Example 4.

Film properties of the obtained gas-barrier film are shown in Table 2.

### EXAMPLE 17

In the same manner as Example 13, a gas-barrier film laminated with non-drawn polyethylene film was obtained by laminating a non-drawn polyethylene film of 40 μm on the gas-barrier layer of the gas-barrier film obtained in Example 5.

Film properties of the obtained gas-barrier film are shown in Table 2.

### EXAMPLE 18

In the same manner as Example 13, a gas-barrier film laminated with non-drawn polyethylene film was obtained by laminating a non-drawn polyethylene film of 40 μm on the gas-barrier layer of the gas-barrier film obtained in Example 6.

Film properties of the obtained gas-barrier film are shown in Table 2.

### EXAMPLE 19

In the same manner as Example 13, a gas-barrier film laminated with non-drawn polyethylene film was obtained by laminating a non-drawn polyethylene film of 40 μm on the gas-barrier layer of the gas-barrier film obtained in Example 7.

Film properties of the obtained gas-barrier film are shown in Table 2.

### EXAMPLE 20

In the same manner as Example 13, a gas-barrier film laminated with non-drawn polyethylene film was obtained by laminating a non-drawn polyethylene film of 40 μm on the gas-barrier layer of the gas-barrier film obtained in Example 8.

Film properties of the obtained gas-barrier film are shown in Table 2.

### EXAMPLE 21

In the same manner as Example 13, a gas-barrier film laminated with non-drawn polyethylene film was obtained by laminating a non-drawn polyethylene film of 40 μm on the gas-barrier layer of the gas-barrier film obtained in Example 9.

Film properties of the obtained gas-barrier film are shown in Table 2.

### EXAMPLE 22

In the same manner as Example 13, a gas-barrier film laminated with non-drawn polyethylene film was obtained by laminating a non-drawn polyethylene film of 40 μm on the gas-barrier layer of the gas-barrier film obtained in Example 10.

Film properties of the obtained gas-barrier film are shown in Table 2.

### EXAMPLE 23

In the same manner as Example 13, a gas-barrier film laminated with non-drawn polyethylene film was obtained by laminating a non-drawn polyethylene film of 40 μm on the gas-barrier layer of the gas-barrier film obtained in Example 11.

Film properties of the obtained gas-barrier film are shown in Table 2.

### EXAMPLE 24

In the same manner as Example 13, a gas-barrier film laminated with non-drawn polyethylene film was obtained by laminating a non-drawn polyethylene film of 40 μm on the gas-barrier layer of the gas-barrier film obtained in Example 12.

Film properties of the obtained gas-barrier film are shown in Table 2.

### COMPARATIVE EXAMPLE 5

In the same manner as Example 13, a gas-barrier film laminated with non-drawn polyethylene film was obtained by laminating a non-drawn polyethylene film of 40 μm on the gas-barrier layer of the gas-barrier film obtained in Comparative Example 4.

Gas-barrier properties before and after Gelbo-Flex Test of the obtained gas-barrier film were evaluated and the results are shown in Table 2.

TABLE 2

| | Oxygen permeation and | Oxygen permeation and |
|---|---|---|
| | transmission rate before | transmission rate after |
| | Gelbo-Flex Test | Gelbo-Flex Test |
| Example | (cc/m²•day•atm) | (cc/m²•day•atm) |
| Example 13 | 0.4 | 1.2 |
| Example 14 | 0.2 | 0.7 |
| Example 15 | 0.9 | 2.8 |
| Example 16 | 2.2 | 5.6 |
| Example 17 | 6.0 | 12 |
| Example 18 | 17 | 18 |
| Example 19 | 8.9 | 16 |
| Example 20 | 5.1 | 11 |
| Example 21 | 0.7 | 2.6 |
| Example 22 | 0.5 | 1.0 |
| Example 23 | 0.5 | 1.2 |
| Example 24 | 0.4 | 2.0 |
| Comparative | 100 | 240 |
| Example 5 | | |

[Effect of the Invention]

According to the present invention a gas-barrier film having excellent appearance and high performance gas-barrier properties is obtained, in case a gas-barrier layer using a gas-barrier material comprising polyvinyl alcohol type resin, silicon alkoxide hydrolyzate and polyethylene oxide is laminated on a thermoplastic resin film.

The present invention should not be bound by a theory, but it is thought that the gas-barrier material of the present invention comprising polyvinyl alcohol type resin, silicon alkoxide hydrolyzate and polyethylene oxide forms a gas-barrier layer having high performance gas-barrier properties on one hand, it becomes possible to form a chemical structure enabling to moderate the generation of cracks in the gas-barrier layer caused by the volume shrinkage accompanied with dealchoholation of silicon alkoxide hydrolyzate, polycondensation and hydrogen bonding among silicon alkoxide hydrolyzate each other, polycondensation and hydrogen bonding of silicon alkoxide hydrolyzate and polyvinyl alcohol type resin on the other.

1. A gas-barrier material comprising polyvinyl alcohol type resin, silicon alkoxide hydrolyzate and polyethylene oxide.

2. A gas-barrier material of claim 1 in which the silicon alkoxide hydrolyzate is a product in which a part or all of alkoxy groups of the silicon alkoxide are hydrolyzed, polycondensate of said partially hydrolyzed product, polycondensate of silicon alkoxide, product in which a part or all of alkoxy groups of said polycondensate are hydrolyzed or a mixture thereof.

3. A preparation process of the gas-barrier material set forth in claim 1 comprising to hydrolyze silicon alkoxide under stirring in a solvent using a hydrolysis catalyst in the presence of at least either of polyvinyl alcohol type resin and polyethylene oxide or in the absence of both and to keep stirring the obtained product until a homogeneous phase is formed, after mixing thereto at least either of polyvinyl alcohol type resin and polyethylene oxide in case of necessity to obtain the desired composition, and characterized by using said polyvinyl alcohol type resin, silicon alkoxide and polyethylene oxide in such proportion that the ratio by weight of polyvinyl alcohol type resin and silicon alkoxide is 100:200 to 100:600 and the ratio by weight of polyvinyl alcohol type resin and polyethylene oxide is 100:0.1 to 100:5.

4. The process of claim 3 to remove the hydrolysis catalyst out of the system, after polyvinyl alcohol type resin, silicon alkoxide, polyethylene oxide, and solvent have been mixed and silicon alkoxide has been hydrolyzed by mixing a hydrolysis catalyst under stirring.

5. The process of claim 3 to mix polyvinyl alcohol type resin and polyethylene oxide, after silicon alkoxide, solvent and hydrolysis catalyst have been mixed, silicon alkoxide has been hydrolyzed under stirring and the hydrolysis catalyst has been removed from said mixture out of the system.

6. The process of claim 3 to remove the hydrolysis catalyst out of the system, after silicon alkoxide, solvent and hydrolysis catalyst have been mixed, silicon alkoxide has been hydrolyzed under stirring and then polyvinyl alcohol type resin and polyethylene oxide have been mixed.

7. A gas-barrier film in which a thermoplastic resin film and a gas-barrier layer formed by the gas-barrier material of claim 1 are laminated.

8. A gas-barrier film in which a thermoplastic resin film and a gas-barrier layer formed by the gas-barrier material of claim 1 are laminated through the intermediary of an anchor coat layer.

9. The gas-barrier film set forth in claims 7 or 8 made by laminating a sealing layer, formed by a thermoplastic resin with lower melting point than the thermoplastic resin constituting said thermoplastic resin film, on the surface of the gas-barrier layer at the opposite side to the surface on which the thermoplastic resin film is laminated.

10. The gas-barrier film set forth in claim 9 whose gas-barrier properties after a bending fatigue test are 100 cc/m²·day·atm or less.

11. A preparation process of the gas-barrier film set forth in any of claims 7-10 characterized by conducting an aging treatment after forming a gas-barrier layer by coating the gas-barrier material of claim 1 on the surface of a thermoplastic resin film and drying at 80° C. to the lower temperature than the melting point of said thermoplastic resin film by 10° C.
